(19) United States
(12) Patent Application Publication
(10) Pub. No.: US 2005/0107563 A1
(43) Pub. Date: May 19, 2005

(54) Methods for manufacturing polyurethanes

(75) Inventors: Jinlian Hu, Hung Hom (CN); Zhuohong Yang, Hung Hom (CN); Kwok-Wing Yeung, Hung Hom (CN); Subrata Mondal, Hung Hom (CN)

Correspondence Address: BURNS DOANE SWECKER & MATHIS L L P, POST OFFICE BOX 1404, ALEXANDRIA, VA, 22313-1404, US

(73) Assignee: The Hong Kong Polytechnic University, Hung Hom (CN)

(21) Appl. No.: 10/715,552

(22) Filed: Nov. 19, 2003

(51) Int. Cl. C08G 18/00

(52) U.S. Cl. 528/44

(57) ABSTRACT

This invention provides water-dispersible polyurethanes made by a difunctional alcohol, a difunctional isocyanate, and a chain extender containing reactive hydrogen groups.

### FIELD OF THE INVENTION

This invention relates to methods for manufacturing polyurethanes, particularly those having shape memory capability and more particularly their application to textiles and garments.

### BACKGROUND OF THE INVENTION

Shape memory polyurethane as polymer foams with cellular structure are known. They have characteristic properties such as resilience and heat insulation, and there are a variety of commercial products utilizing these properties. These foams are usually molded in a desired shape and used in their molded-state, except in the case of form-in-place molding.

Shape memory polymer moldings remain deformed if they are deformed at a temperature higher than the glass transition temperature (T_{g}) of the polymer and lower than the molding temperature, and then cooled below T_{g} in the deformed state. Shape memory polymer moldings in the deformed state recover their original molded shape when heated to a temperature higher than T_{g} and lower than the molding temperature. In other words, shape memory polymer moldings take on the as-molded shape and the deformed shape as the temperature changes.

In the case of fabrics, advanced finishing techniques seek to employ anti-wrinkle agents or similar to both improve the feel and allow for retention of the intended shape of the garment or fabric during use or storage.

Current anti-wrinkle agents are mainly based on methylol compounds, such as dimethylol ethylene urea, dimethylol dihydroxyethylene urea (DMDHEU), urea-formaldehyde, melamine-formaldehyde condensates, and so on. However, these agents may liberate formaldehyde during fiber finishing operations and can cause occupational health problems. Formaldehyde is a generally environmentally unfriendly by-product of the process.

Although polycarboxylic acid can also be used as an anti-wrinkle agent under catalyst, as described under U.S. Pat. Nos. 4,975,209, 4,820,307 and 5,221,285, these crosslinked polycarboxylic acids tend to weaken the tear strength of fabrics.

Use of blocked polyisocyanates as anti-wrinkle agents were reported in Textilveredelung, 2 (7), 441 (1967); Textilverdelung, 13 (11), 454 (1978); Ind. Eng. Chem. Prod Res. Dev., 21 (1), 4-11 (1982) and U.S. Pat. No. 5,508,370 with DMDHEU as additive.

U.S. Pat. Nos. 4,132,817; 4,171,395; 4,405,393; 4,512, 831 and 4,715,912 disclose processes by which a layer of blown cellular polyurethane, i.e. polyurethane foam, can be formed on a textile such as a fabric or carpet back. However, this process does not use an aqueous dispersion and the polyurethane shows no shape memory effect.

Processes for preparing aqueous polyurethane dispersions are generally known. However, there has never been proposed aqueous shape memory polyurethane. According to the arts up to the present, there has not been a process for introducing carboxylic group(s) to polyurethane to form aqueous shape memory polyurethane.

### OBJECTS OF THE INVENTION

Therefore, it is an object of this invention to resolve at least one or more of the problems as set forth in the prior art. As a minimum, it is an object of this invention to provide the public with a useful choice.

### SUMMARY OF THE INVENTION

Accordingly, this invention provides a process for manufacturing a polyurethane including the steps of:
a) mixing a difunctional alcohol with a difunctional isocyanate to form a first mixture;
b) heating the first mixture;
c) adding a chain extender to the heated first mixture to form a second mixture, said chain extender containing reactive hydrogen groups; and
d) neutralizing the second mixture by a neutralizer to form the polyurethane.

Preferably, the first mixture is heated at a temperature of about 80 degree Celsius to about 100 degree Celsius in step b), and preferably for about two to about five hours.

Preferably, the difunctional isocyanate is selected from the group consisting of aliphatic diisocyanates, aromatic diisocyanates, alicyclic diisocyanates, and their mixture thereof. Said aliphatic diisocyanates can be selected form the group consisting of isophorone diisocyanate, 4,4-dicyclohexylmethane diisocyanate, 1,6-hexamethylene diisocyanate and tetramethylxylylene diisocyanate. Said aromatic diisocyanates can be selected form the group consisting of diphenylemethane-4,4-diisocyanate, tolulene diisocyanate and 1,6-hexamethylene diisocyanate.

Preferably, the difunctional alcohol is selected from the group consisting of polyether diol, polyester diol, polycarbonate, polycaprolactone, and their mixture thereof. More preferably, the difunctional alcohol is selected from the group consisting of polypropylene glycol, 1,4-butane glycol adipate, polytetramethylene glycol, polyethylene glycol, bisphenol-A+propylene oxide, and their mixture thereof.

Preferably, said chain extender is selected from 1,4-butanediol, 1,3-propanediol, 1,2-ethanediol, 4,4′-dihydroxy biphenyl, 2,2-dimethylolpropanic acid, and their mixture thereof.

Optionally, the molar ratio between the difunctional isocyanate and the difunctional alcohol is from about 1:1.5 to about 1:5.0.

Preferably, the neutralizer is selected from the group consisting of water-soluble tertiary amines, alkali metal hydrides, and their mixtures thereof. The molar ratio of the reactive hydrogen groups to the neutralizer is preferred to be from about 1:0.5 to about 1:1.2.

The process of this invention can be performed without using a solvent. Alternatively, the process can be performed in the presence of not more than 30 weight percent of a water-miscible solvent having no reactive hydrogen. In such a case, the process of this invention may further include the steps of:
e) dispersing the polyurethane in water. The amount of water is preferred to be about 5% to about 50 weight percent with respect to the overall solid content, and/or about 5 degree Celsius to about 80 degree Celsius
f) removing the water-miscible solvent.

This invention also provided a polyurethane manufactured by the above processes. The polyurethane may have a tensile modulus varying with temperature, and a glass transition temperature. The ratio of the tensile modulus at temperatures 10° C. higher than the glass transition or melting temperature, to the tensile modulus at temperatures 10° C. lower than the glass transition temperature, is about 50 to 400. Preferably, the glass transition or melting temperature is in the range of about −30° C. to about 80° C.

### DETAILED DESCRIPTION OF THE PREFERRED EMBODIMENT

This invention is now described by way of example with reference to the following paragraphs.

Objects, features, and aspects of the present invention are disclosed in or are obvious from the following description. It is to be understood by one of ordinary skill in the art that the present discussion is a description of exemplary embodiments only, and is not intended as limiting the broader aspects of the present invention, which broader aspects are embodied in the exemplary constructions.

Conventional shape memory polyurethane, which exhibits rubber elasticity above the glass transition point, was produced by permitting the terminal of the polymer to possess a large amount of excess [NCO] so that the terminal [NCO] and the urethane link part react with each other. The crosslinking between molecules proceeds positively with the forming of the relatively stiff allophanate link, which may lead to bad hand feeling and low stability of the emulsion. To the contrary, this invention uses a difunctional isocyanate, a difunctional alcohol, and a chain extender containing reactive hydrogen group, followed by neutralization. In this context, the term “reactive hydrogen group” refers to substituent groups having a relatively acidic hydrogen like carboxylic groups, hydroxyl groups, phenolic groups, and so on. Because of this, in the present invention, it is possible to obtain aqueous shape memory polyurethane, which has a glass transition or melting point in the range of about −30° C. to about 80° C., exhibits a shape memory effect and can be applied to textiles and garments.

The raw materials that can be used in the present invention are illustrated in the following. However, it should be noted that the following raw materials are merely examples, and other suitable materials may be used provided that they fulfill the following general requirements.

With regard to difunctional isocyanate, it is possible to represent OCN—R—NCO by the general formula. R may be an aliphatic hydrocarbon chain having a combination of C—C single or multiple bonds, or benzene rings. In fact, these is no particular restriction on the R group. As examples, it is possible to enumerate, for example, 2,4-toluene diisocyanate, 4,4′-diphenylmethane diisocyanate, carbodiimide-modified 4,4′-diphenylmethane diisocyanate, hexamethylene diisocyanate, and so on.

The difunctional alcohol can be represented by the general formula OH—R′—OH. R′ may be an aliphatic hydrocarbon chain having a combination of C—C single or multiple bonds, or benzene rings. As examples, it is possible to enumerate, for example, polypropylene glycol, 1,4-butane glycol adipate, polytetramethylene glycol, polyethylene glycol, bisphenol-A+propylene oxide, etc.

As the example of the difunctional chain extender containing active hydrogen groups, it is possible to represent OH—R″—OH by the general formula. R″ may be an aliphatic hydrocarbon chain having a combination of C—C single or multiple bonds, or benzene rings, group having one or two carboxylic acid, and so on. Suitable examples of the difuncational chain extender may include 1,4-butanediol, 1,3-propanediol, 1,2-ethanediol, 4,4′-dihydroxy biphenyl, 2,2-dimethylolpropanic acid.

It is possible to use dimethylformamide, acetone, or other suitable solvents to carry out the reaction. However, it is possible to use no solvent at all if all as generally known in the polymer field.

The synthesis of the aqueous shape memory polyurethane is performed by the prepolymer method using the above-mentioned isocyanate, polyol, and chain extender, and, if necessary, catalysts. The synthesis of the polyurethane is explained in the following paragraphs.

Generally, the diisocyanate and polyol are reacted at a specific formulation ratio A=[NCO]/[OH] molar ratio (about 1.5 to 5.0) to synthesize a prepolymer. Then, chain extender was added. After several hours, a neutralizer was also added to form anionic shape memory polyurethane. In the reaction, though the reaction of NCO with carboxylic group (COOH) does occur, the reaction rate is slower than the reaction of NCO with OH. Thus, under this reaction condition, some cross-linkage may be formed by amide bonds resulting from the reaction of NCO with COOH. Practically, some cross-linkage occurs in the stage of forming the polyurethane polymer.

An aqueous polyurethane dispersion can be readily prepared from the polyurethane prepolymer obtained above. The stage generally includes the steps of (1) neutralizing the carboxylic group(s) with a neutralizer, (2) adding water to disperse the neutralized prepolymer, and (3) performing a chain-extension of the dispersed prepolymer with water or with a diamine, a diol, a triol, or a triamine containing an amine group having at least one reactive hydrogen per nitrogen atom, or a mixture thereof. The steps can be performed simultaneously.

In the neutralization reaction, a water-soluble tertiary amine, an alkali metal hydroxide, or a mixture thereof is preferably used as a neutralizer, although other neutralizer may be used. Most preferably, the amount of the neutralizer is equal to the amount needed to neutralize all the carboxylic groups contained in the prepolymer. However, the amount may be the amount needed to neutralize only 50% of the whole amount of carboxylic groups. Thus the molar ratio of the carboxylic group to the neutralizer is desirably from 1:0.5 to 1:1.2.

Further, the gist of the present invention resides in a shape memory polyurethane having the above-mentioned gist, which is characterized in that the ratio of the tensile modulus at temperatures 10° C. higher than the glass transition point, to the tensile modulus at temperatures 10° C. lower than the glass transition point, is about 50 to 400. According to the present invention, it is possible to obtain an aqueous shape memory polyurethane which has the shape memory function, exhibits shape recovery effect above its glass transition point or melting point, and possesses a glass transition or melting point in the range of −30° C. about 80° C.

Thus, this kind of polymer has potential application in textile as finishing agent. Their uses to textile and garments become capable of by finishing with fabrics. In fact, general finishing methods could use the aqueous shape memory polyurethane for the wrinkle resistance finishing of textiles and garments.

In the case where the shape memory polymer has a glass transition temperature (T_{g}) or melting temperature (Tₘ) lower than room temperature (e.g., about −5° C.) and the shape memory property is imparted to the fabrics. The thus obtained fabrics give the soft hand when used at room temperature, which is higher than the T_{g} (Tₘ). Moreover, it may not wrinkle nor deform even when it is washed or left in a wardrobe for a long time. Considering their uses, it may be favorably applied to the creases of slacks and the pleats of skirts.

If the shape memory polymer has a T_{g} (Tₘ) higher than room temperature (e.g, about 40° C.), the finished fabric can remember the shape given when it is cooled below the T_{g} (Tₘ). Then when it wrinkles or deforms after wearing, washing or prolonged storage in a wardrobe, it easily restores its original shape it remembers, eliminating wrinkles or deformation, upon heating above the T_{g} (Tₘ), such as by using drier or in hot water. Therefore, it may also be favorably applied to the collars, cuffs, and shoulder pads of utility shirts.

### EXAMPLES

### Example 1

Polycaprolactone diol (Mw 4000, 160 g) and diphenylmethane-4,4′-diisocyanate (MDI, 33.0 g) were added to a four-necked flask equipped with a stirrer, a dry nitrogen inlet, and a reflux condenser with N,N-dimethylformamide 120 ml as a solvent. The reaction mixture was reacted at 90° C. for 3 hours to obtain a polyurethane prepolymer. Then chain extender including carboxylic groups was added and continued to react for two hours. Triethylamine (as a neutralizing agent) were added to a mixture of the above in an amount equivalent to the molar amount of carboxylic acid. The neutralization was performed for 10 minutes. While the mixture is vigorously stirred at 1000-2000 rpm, a certain amount of water was added at a constant rate to order to disperse the polymer. The amount of water was determined to be an amount needed to control the overall solid content of the final dispersion at 30% or 35%.

### Example 2

139 g of polycaprolactone diol, add 23.6 g of 4,4-diphenylmethane diisocyanate were added to a 1 1-separator type reactor. The reaction was carried out at 80° C. for 3 hours followed by addition of 4.5 g of dimethylol propionic acid, 5.7 g of 1,4-dibutyldiol and 7.2 g hexamethylene diisocyanate to initiate the chain extending reaction, which was carried out at 90° C. for 2 hours. This process may be carried out with or without solvent. Then, suitable neutralizer such as triethylamine (4.0 g) was added. Finally, 552 g of deionized water was added to disperse the reaction mixture to obtain dispersion with 25% solid content.

Results of anti-wrinkle treatment by using aqueous shape memory polyurethane are shown as follows:

TABLE 1
Properties of Treated Cotton Fabric

| | Case 1 | Case 2 | Case 3 |
|---|---|---|---|
| Add-on percentage (%) | 6.47 | 6.68 | 6.75 |
| Dry crease recovery angle (Warp and | 274 | 276 | 280 |
| Weft) | | | |
| Tear strength retention percentage (%) | 86 | 83 | 82 |
| Durable Press | 4.2 | 4.2 | 4.3 |

Note:
Dry crease recovery angle for untreated cotton fabric is 212.degree

TABLE 2
Properties of treated cotton fabric in hot water

| | Original | Case 1 | Case 2 |
|---|---|---|---|
| Add-on percentage (%) | — | 5.2 | 4.8 |
| Crease retention in 50° C. water | 1.3 | 3.9 | 3.7 |
| Flat appearance in 50° C. water | 2.5 | 4.1 | 4 |
| Tear strength retention percentage | 100 | 102 | 98 |
| (%) | | | |

Notes:
The crease retention and flat appearance were measured by using AATCC standard.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A process for manufacturing a polyurethane including the steps of:
a) mixing a difunctional alcohol with a difunctional isocyanate to form a first mixture;
b) heating the first mixture;
c) adding a chain extender to the heated first mixture to form a second mixture, said chain extender containing reactive hydrogen groups; and
d) neutralizing the second mixture by a neutralizer to form the polyurethane.

2. The process of claim 1, wherein the first mixture is heated at a temperature of about 80 degree Celsius to about 100 degree Celsius in step b).

3. The process of claim 2, wherein the first mixture is heated for about two to about five hours.

4. The process of claim 1, wherein the difunctional isocyanate is selected from the group consisting of aliphatic diisocyanates, aromatic diisocyanates, alicyclic diisocyanates, and their mixture thereof.

5. The process of claim 4, wherein said aliphatic diisocyanates is selected from the group consisting of isophorone diisocyanate, 4,4-dicyclohexylmethane diisocyanate, 1,6-hexamethylene diisocyanate and tetramethylxylylene diisocyanate.

6. The process of claim 4, wherein said aromatic diisocyanates is selected from the group consisting of diphenylemethane-4,4-diisocyanate, tolulene diisocyanate and 1,6-hexamethylene diisocyanate.

7. The process of claim 1, wherein the difunctional alcohol is selected from the group consisting of polyether diol, polyester diol, polycarbonate, polycaprolactone, and their mixture thereof.

8. The process of claim 7, wherein the difunctional alcohol is selected from the group consisting of polypropylene glycol, 1,4-butane glycol adipate, polytetramethylene glycol, polyethylene glycol, bisphenol-A+propylene oxide, and their mixture thereof.

9. The process of claim 1, wherein said chain extender is selected from 1,4-butanediol, 1,3-propanediol, 1,2-ethanediol, 4,4′-dihydroxy biphenyl, 2,2-dimethylolpropanic acid, and their mixture thereof.

10. The process of claim 1, wherein the molar ratio between the difunctional isocyanate and the difunctional alcohol is from about 1:1.5 to about 1:5.0.

11. The process of claim 1, wherein the neutralizer is selected from the group consisting of water-soluble tertiary amines, alkali metal hydrides, and their mixtures thereof.

12. The process of claim 11, wherein and the molar ratio of the reactive hydrogen groups to the neutralizer is from about 1:0.5 to about 1:1.2

13. The process of claim 1 being performed without using a solvent.

14. The process of claim 1 being performed in the presence of not more than weight percent of a water-miscible solvent having no reactive hydrogen.

15. The process of claim 14 further including the steps of:
e) dispersing the polyurethane in water;
f) removing the water-miscible solvent.

16. The process as claimed in claim 15, wherein the amount of water is about 5% to about 50 weight percent with respect to the overall solid content.

17. The process as claimed in claim 15, wherein the temperature of the water is about 5 degree Celsius to about 80 degree Celsius.

18. Polyurethane manufactured by the process of claim 1.

19. Polyurethane of claim 18 having a tensile modulus varying with temperature, and a glass transition or melting temperature, wherein the ratio of the tensile modulus at temperatures 10° C. higher than the glass transition or melting temperature, to the tensile modulus at temperatures 10° C. lower than the glass transition or melting temperature, is about 50 to 400.

20. Polyurethane of claim 19, wherein the glass transition or melting temperature is in the range of about −30° C. to about 80° C.

21. Polyurethane having a tensile modulus varying with temperature, and a glass transition or melting temperature, wherein the ratio of the tensile modulus at temperatures 10° C. higher than the glass transition or melting temperature, to the tensile modulus at temperatures 10° C. lower than the glass transition or melting temperature, is about 50 to 400.

22. Polyurethane of claim 21, wherein the glass transition or melting temperature is in the range of about −30° C. to about 80° C.
